(19) United States
(12) Patent Application Publication
(10) Pub. No.: US 2026/0119335 A1
(43) Pub. Date: Apr. 30, 2026

(54) TECHNIQUES FOR GENERATING BACKUP POLICIES BASED ON BACKUP POSTURE CONTROLS

(71) Applicant: Eon IO, Ltd., Tel Aviv (IL)

(72) Inventors: Ron KIMCHI, Tel Aviv (IL); Assaf NATANZON, Tel Aviv (IL); Ofir EHRLICH, Tel Aviv (IL); Eugene MARIN, Ramat Gan (IL); Moshe ATLOW, Tsur Hadassa (IL)

(73) Assignee: Eon IO, Ltd., Tel Aviv (IL)

(21) Appl. No.: 19/345,184

(22) Filed: Sep. 30, 2025

Related U.S. Application Data
(63) Continuation-in-part of application No. 18/928,038, filed on Oct. 27, 2024, now Pat. No. 12,455,793.
(63) Continuation-in-part of application No. 18/928,039, filed on Oct. 27, 2024.

(51) Int. Cl. G06F 11/14; G06F 11/34

(52) U.S. Cl. CPC G06F 11/1461; G06F 11/1464; G06F 11/3433

(57) ABSTRACT

A method and system for generating backup policies based on backup posture controls is presented. The method includes probing one or more accounts on a cloud infrastructure so as to identify content of cloud resources hosted by the cloud infrastructure in association with the accounts; retrieving a set of backup posture controls, wherein the set of backup controls defines backup requirements on the identified cloud resources; analyzing the backup requirements to create optimization rules and workload-specific rules; creating at least one backup policy based on the optimization rules and workload-specific rules; and assigning the at least one backup policy to a backup system to allow backup operations of the cloud resources based on the at least one backup policy.

### CROSS-REFERENCE TO RELATED APPLICATIONS

The present application is a continuation in part of U.S. Non-Provisional application Ser. No. 18/928,039, filed on Oct. 27, 2024, and U.S. Non-Provisional application Ser. No. 18/928,038, filed on Oct. 27, 2024, the contents of which are hereby incorporated by reference.

### TECHNICAL FIELD

The present disclosure relates generally to backup systems, and more particularly to managing backup policies in such systems.

### BACKGROUND

A cloud infrastructure includes hardware and software components for supporting cloud computing. Examples of cloud infrastructures include Amazon® Web Services, Microsoft® Azure, and Google® Cloud Platform. After opening an account on a cloud infrastructure, a user can associate data resources, such as databases or virtual machines, with the account. The data resources are then hosted by the cloud infrastructure in association with the account.

In some cases, backing up a data resource includes taking a snapshot of the resource (e.g., periodically) and copying the snapshot to another location. Alternatively, other techniques, such as using an agent to copy directly from the data resource, are used.

In computing environments, organizations commonly employ backup policies to manage the protection and recovery of digital data. A backup policy generally defines a set of guidelines and procedures that govern how data is copied, stored, and maintained. Such policies typically ensure that data is backed up at regular intervals, preserved in a secure manner, and restored when needed in the event of data loss, corruption, or system failure. The implementation of a well-defined backup policy is important for ensuring data protection, maintaining business continuity, and supporting disaster recovery efforts.

Conventional backup solutions and products commonly incorporate mechanisms for detecting, controlling, and managing violations of backup policies. These mechanisms are employed to maintain adherence to organizational requirements, ensure data protection, and support regulatory or compliance objectives.

Challenges exist with conventional backup solutions. While such solutions are generally capable of monitoring whether backup operations are executed in accordance with defined policies, they are limited in their ability to verify that the policies themselves are correctly configured or that they comply with overarching organizational or regulatory requirements. For instance, under regulations such as the General Data Protection Regulation (GDPR), data containing personally identifiable information (PII) must not be replicated or stored outside designated geographic regions (e.g., outside of Europe). However, certain backup policies may inadvertently direct data to restricted locations, thereby violating such requirements. Existing policy mechanisms lack the capability to detect or prevent such erroneous configurations.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, the method may include probing one or more accounts on a cloud infrastructure so as to identify content of cloud resources hosted by the cloud infrastructure in association with the accounts. The method may also include retrieving a set of backup posture controls, where the set of backup controls defines backup requirements on the identified cloud resources. The method may furthermore include analyzing the backup requirements to create optimization rules and workload-specific rules. The method may in addition include creating at least one backup policy based on the optimization rules and workload-specific rules. The method may moreover include assigning the at least one backup policy to a backup system to allow backup operations of the cloud resources based on the at least one backup policy. Other embodiments of this aspect include corresponding computer systems, apparatus, and computer programs recorded on one or more computer storage devices, each configured to perform the actions of the methods.

In one general aspect, a non-transitory computer-readable medium may include one or more instructions that, when executed by one or more processors of a device, cause the device to: probe one or more accounts on a cloud infrastructure so as to identify content of cloud resources hosted by the cloud infrastructure in association with the accounts; retrieve a set of backup posture controls, where the set of backup controls defines backup requirements on the identified cloud resources; analyze the backup requirements to create optimization rules and workload-specific rules; create at least one backup policy based on the optimization rules and workload-specific rules; and assign the at least one backup policy to a backup system to allow backup operations of the cloud resources based on the at least one backup policy. Other embodiments of this aspect include corresponding computer systems, apparatus, and computer programs recorded on one or more computer storage devices, each configured to perform the actions of the methods.

In one general aspect, a system may include a processing circuitry. The system may also include a memory, the memory containing instructions that, when executed by the processing circuitry, configure the system to: probe one or more accounts on a cloud infrastructure so as to identify content of cloud resources hosted by the cloud infrastructure in association with the accounts. The system may in addition retrieve a set of backup posture controls, where the set of backup controls defines backup requirements on the identified cloud resources. The system may moreover analyze the backup requirements to create optimization rules and workload-specific rules. The system may also create at least one backup policy based on the optimization rules and workload-specific rules. The system may furthermore assign the at least one backup policy to a backup system to allow backup operations of the cloud resources based on the at least one backup policy. Other embodiments of this aspect include corresponding computer systems, apparatus, and computer programs recorded on one or more computer storage devices, each configured to perform the actions of the methods.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 shows a schematic illustration of a system for backing up multiple cloud resources, in accordance with some disclosed embodiments.

FIG. 2 is a schematic illustration of an example user interface for creating a backup policy, in accordance with some disclosed embodiments.

FIG. 3 is a schematic illustration of an example user interface for creating a backup posture control, in accordance with some disclosed embodiments

FIG. 4 shows a flowchart describing the method for optimizing backup posture controls in accordance with the disclosed embodiments.

FIG. 5 shows a flowchart describing the method for optimizing backup posture controls in accordance with the disclosed embodiments.

FIG. 6 is a schematic diagram of an example physical machine implementation of a backup system, in accordance with an embodiment of the present disclosure.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

Typically, cloud resources on a cloud infrastructure are automatically backed up in accordance with a user-defined backup policy. The backup policy includes one or more parameters, such as the frequency with which the backup is to occur, the number of backup copies to be made, and the location(s) at which the backup copies are to be stored.

Conventionally, the cloud resources included in a backup policy are those specified explicitly by the user, those that possess general properties specified by the user, such as the property of being of a particular type, and/or those that have been tagged by the user with a particular tag. However, in many cases, more flexibility is required. For example, the user may wish to include resources that store a particular class of data (e.g., sensitive data), run in a particular type of runtime environment (e.g., a production environment), and/or run a particular type of application. Even if the user can somehow identify such resources that satisfy these conditions, manually tagging these resources might be impractical. Moreover, the set of data resources satisfying these conditions might change over time.

To address this challenge, the disclosed embodiments provide content-based backup policies in which data resources are included based on the content of the data resources, rather than merely based on general properties or tags. To facilitate defining such a policy, one or more processors probe the user's accounts on the cloud infrastructure, typically periodically, so as to identify the data resources hosted by the cloud infrastructure in association with the accounts and, in addition, the content of these data resources. For example, the processors may identify classes of data stored in the data resources, applications installed on the data resources, and/or metadata variables saved on the data resources. Based on the identified content, the processors identify the data resources to be included in the policy, and back up the identified data resources in accordance with the specified backup parameters.

In many cases, it is desired that each cloud resource be backed up in accordance with any relevant requirements (or “rules”). For example, due to regulatory requirements, there may be constraints on the geographic regions in which sensitive data may be stored. As another example, a requirement may stipulate that at least one backup copy be in a different geographic region from the data resource. However, it is often prohibitively difficult to ascertain, manually, whether each data resource is backed up in accordance with the relevant requirements.

To address this challenge, the disclosed embodiments provide content-based backup posture controls, each of which includes one or more backup requirements. In addition to probing the user's accounts as described above, the processors identify the data resources to be included in the backup posture control based on the content of the data resources. The processors then ascertain whether each of the data resources included in the backup posture control is backed up in accordance with the backup requirements of the respective control. In response to any one of the data resources not being backed up in accordance with the backup requirements, the processors 32 output a warning.

In some disclosed embodiments, content-based backup posture controls are used in combination with content-based backup policies. For example, in some cases, a backup requirement may be missed during the definition of the policies, e.g., due to the large number and/or complexity of the policies, due to the large number and/or complexity of the backup requirements, or due to the backup requirement not having been relevant when the policy was defined. The content-based backup posture controls facilitate modifying the policies (e.g., adding a policy and/or modifying an existing policy) to account for the missed requirement.

For example, in one hypothetical scenario, a user defines a backup policy specifying that all European data resources running Microsoft® Windows should be backed up to the United States, without accounting for regulations forbidding European-sourced personally identifiable information (PII) from being stored outside of Europe. For example, such regulations may be issued only after the policy is defined, the user may incorrectly assume that no European data resources running Microsoft® Windows will ever contain PII, or the user may simply forget about the regulations. Even if the user were to define another backup policy specifying that all European data resources containing PII should be backed up to Europe, a data resource running Microsoft Windows and containing personally identifiable information may nonetheless be backed up to the United States per the former backup policy. Hence, the user defines a backup posture control stipulating that no European-sourced PII is to be backed up outside of Europe. Based on the execution of this backup posture control, the user can identify the problem with the former backup policy and then correct this problem by excluding data resources containing PII from the policy.

In other embodiments, content-based backup posture controls are used independently from content-based backup policies. For example, content-based backup posture controls may be particularly helpful for cases in which at least some backups are performed manually and/or with conventional (e.g., tag-based) backup policies that cannot effectively handle content-based requirements, such as a requirement that no European-sourced personally identifiable information be stored outside of Europe.

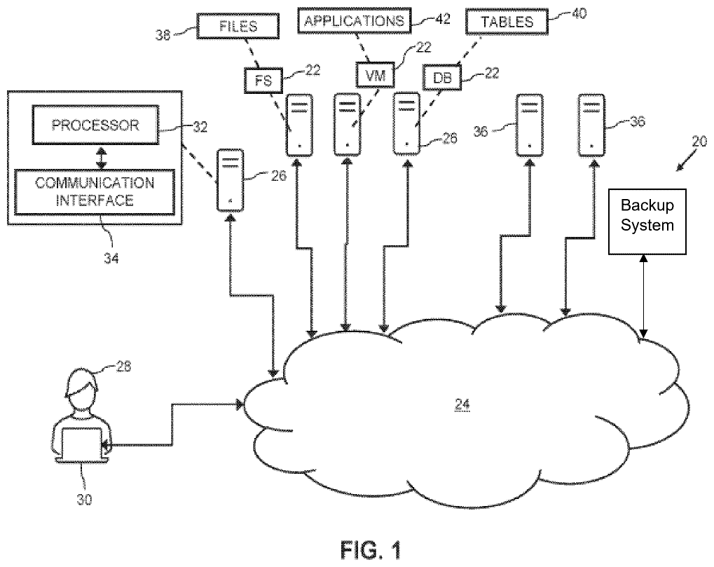

FIG. 1 shows a schematic illustration of a system 20 for backing up multiple data resources 22, in accordance with some disclosed embodiments.

Cloud resources 22 are hosted by a cloud infrastructure 24 in association with one or more accounts. For example, FIG. 1 shows several types of cloud resources 22 residing on servers 26 belonging to cloud infrastructure 24. It should be noted that a single data resource may be distributed across multiple servers 26, and that a user 28 of the accounts typically does not know which server(s) user 28 is using. Servers 26 include respective processors 32 and respective communication interfaces 34, such as respective network interface controllers, via which processors 32 exchange communication as described herein. Cloud resources 22 may include, for example, one or more file systems (FSs), virtual machines (VMs), and databases (DBs) containing tables 40, and/or web services.

Typically, the backup-related functionality described herein is performed cooperatively by processors 32, by executing suitable cloud-computing software. To facilitate this, user 28 provides access to the accounts to the software, e.g., by entering the account IDs and passwords into a web application running on a device 30. In addition, as further described below, user 28 provides to the software, e.g., via the web application, instructions including one or more backup policies and/or backup posture controls. In some such embodiments, the data and instructions entered by the user are communicated to servers 26 via one or more servers on another cloud infrastructure and/or one or more servers that are not cloud-based, which manage the backup-related functionality described herein.

Based on access to the accounts provided by user 28, processors 32 probe the accounts so as to identify cloud resources 22 (i.e., to identify which cloud resources are associated with the accounts) and, in addition, the content of cloud resources 22. Typically, the probing is performed periodically, e.g., at least once daily. Typically, the processors identify the content by taking respective snapshots of cloud resources 22, mounting the snapshots, and then scanning the snapshots. Alternatively, the processors 32 identify the content by scanning the cloud resources directly, using one or more agents installed on servers 26.

In some disclosed embodiments, the identified content includes content of files 38 stored in the cloud resources, such as in a file system. Alternatively or additionally, the identified content includes the respective names of files 38, which may indicate, for example, the type of content in the files and/or the type of environment (e.g., production, development, or testing) in which the files are used.

Alternatively or additionally, the identified content includes the content of tables 40 contained in databases 22. Alternatively or additionally, the identified content includes respective names of tables 40 and/or respective names of fields in tables 40, which may indicate, for example, the type of content in the tables and/or the type of environment (e.g., production, development, or testing) in which the tables are used.

Alternatively or additionally, the identified content includes one or more applications 42 installed on the cloud resources, such as on a virtual machine. Alternatively or additionally, the identified content includes metadata variables associated with applications 42. Such variables may, for example, identify applications 42, indicate the type of environment (e.g., production, development, or testing) in which each application 42 runs, and/or indicate other information associated with the applications, such as the name of a database running in a database application.

Alternatively or additionally, the identified content includes metadata variables that indicate respective network configurations of the cloud resources. The network configurations may, for example, indicate the type of environment (e.g., production, development, or testing) in which each data resource is used.

In some disclosed embodiments, to identify whether a particular application or type of application 42 is installed, the processors scan one or more predefined storage locations at which the particular application or type of application is typically installed. For example, on an Amazon Elastic Compute Cloud (EC2) instance running a Linux® distribution, the configuration files for the database application MySQL are typically installed at /etc/mysql/ or /etc/my.cnf, the binary files are typically installed at /usr/bin/ or /usr/sbin/, and the log files are typically installed at /var/log/mysql/. Alternatively or additionally, to identify data used by a particular application or type of application, the processors scan one or more storage locations at which the data is typically stored. For example, on an EC2 instance running a Linux distribution, the data directory for MySQL is typically /var/lib/mysql/.

Alternatively or additionally, while identifying the content of cloud resources 22, the processors classify the content. For example, in some disclosed embodiments, the processors 32 classify data in a file or database as sensitive, e.g., by virtue of including personally identifiable information, financial information, and/or protected health information. For example, in some disclosed embodiments, the processors 32 use Microsoft Presidio, an open-source library with code for detecting sensitive data, to classify the data.

Following each probing, processors 32 are configured to store information describing the content of each data resource 22. Subsequently, the processors 32 use this information to execute one or more backup policies and/or backup posture controls, as described in detail below. It should be noted that in some cases, an initial probing of the user's accounts is performed only after a backup policy and/or backup posture control has been defined. In executing the backup policies, the processors 32 create backups of cloud resources 22. The backups are typically stored on destination servers 36, each of which may be hosted by cloud infrastructure 24 and/or any other cloud infrastructure, in association with any account.

Typically, as described above, the functionality of each processor 32 is implemented in software. For example, in some disclosed embodiments, each processor 32 is embodied as a programmed processor comprising, for example, a central processing unit (CPU) and/or a Graphics Processing Unit (GPU). Program code, including software programs, and/or data may be loaded for execution and processing by the CPU and/or GPU. The program code and/or data may be downloaded to the processor in electronic form, over a network, for example. Alternatively or additionally, the program code and/or data may be provided and/or stored on non-transitory tangible media, such as magnetic, optical, or electronic memory. Such program code and/or data, when provided to the processor, produce a machine or special-purpose computer, configured to perform the tasks described herein.

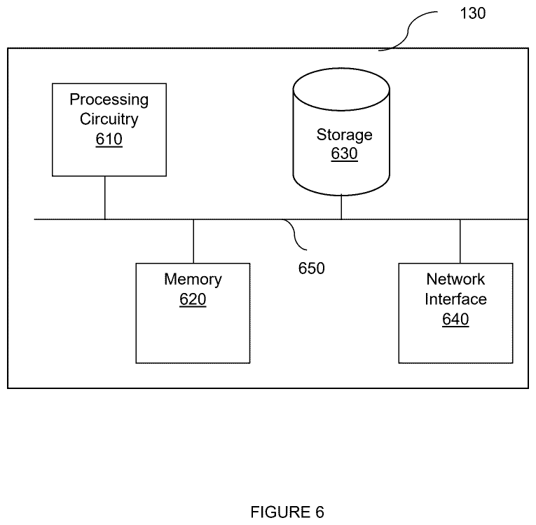

Alternatively to the processors 32, the backup-related functionality described herein may be performed by a backup system 140. The backup system 104 may be deployed on-premises or in a cloud infrastructure that is either cloud Infrastructure 24 or another cloud infrastructure. The backup system 140 is communicatively connected to the servers 26 holding copies of the backup. The backup system 140 may be realized as a virtual machine (or instance), or a physical machine. An example implementation of the backup system 140 is provided in FIG. 6. The backup may include backup files and associated metadata.

In addition to providing access to the user's accounts on cloud infrastructure 24, user 28 defines one or more backup policies. Each backup policy specifies one or more backup parameters and at least one set of one or more resource properties. Backup system 140 is configured to receive the backup policy from the user. Based on the identified content of cloud resources 22, the backup system 140 identifies at least some of the cloud resources 22 that have the specified resource properties. The backup system 140 then backs up the identified cloud resources in accordance with the backup parameters.

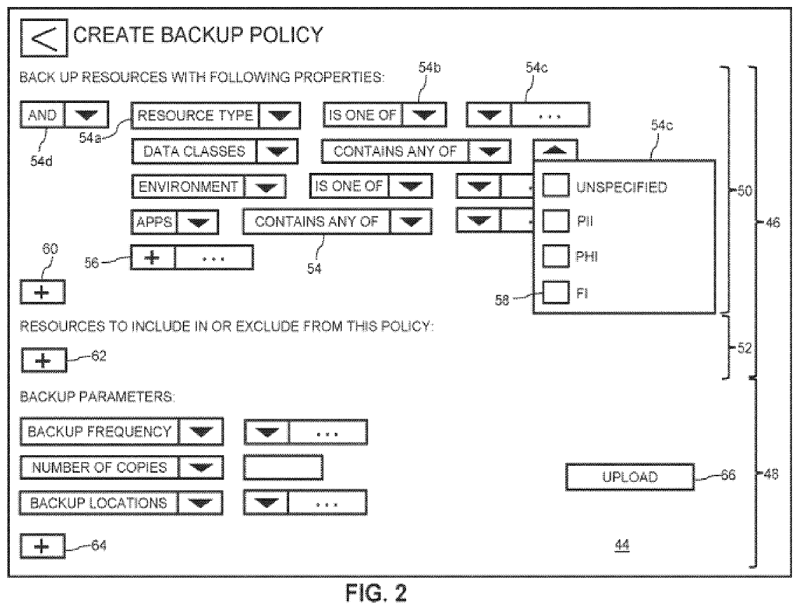

By way of illustration, reference is now made to FIG. 2, which is a schematic illustration of an example user interface 44 for creating a backup policy, in accordance with some disclosed embodiments. In some disclosed embodiments, user interface 44, or any suitable variation thereof, is displayed on device 30 (FIG. 1). The user 28 uses the user interface to create (or “define”) a backup policy, and the backup policy is then uploaded to the processors from device 30, e.g., in response to the user hitting an upload button 66. In some disclosed embodiments, user interface 44 includes multiple dropdown menus 54 for use in defining the backup policy.

In some disclosed embodiments, user interface 44 includes a first section 46, in which the user can specify information to be used for determining the cloud resources to be included in the policy, and a second section 48, in which the user can define the backup parameters to be applied to these cloud resources. In some disclosed embodiments, first section 46 includes a first sub-section 50, in which the user can specify one or more sets of resource properties, and a second sub-section 52, in which the user can specify (explicitly) any cloud resources to be included in or excluded from the policy. The cloud resources included in the policy are those having all the properties of any one of the sets of resource properties, subject to any inclusions and/or exclusions specified in a second sub-section 52.

In some disclosed embodiments, for each set of cloud resource (shown as “RESOURCES” in FIG. 2) properties, a user interface 44 includes a button 56. In response to the user pressing button 56, the user interface adds three dropdown menus 54, via which the user can define a new property: a first menu 54a for selecting the property type, a second menu 54b for selecting a type of condition on the property type, and a third menu 54c for selecting the condition. For example, one possible resource property is that the data resource is of type database or virtual machine. To specify such a property, the user can specify “resource type” in the first menu 54a, specify “is one of” in the second menu 54b, and check respective checkboxes for “database” and “virtual machine” in the third menu 54c.

In some disclosed embodiments, a button 60 allows the user to add a new set of properties. Alternatively or additionally, by toggling a dropdown menu 54d from “AND” to “OR,” the user can assign each property to its own set. For example, it will be supposed that a first set of properties initially includes a property P1, and the user then adds a property P2. If P2 is added while a dropdown menu 54d is set to “AND,” any data resource included in the backup policy would need to have both P1 and P2. On the other hand, if P2 is added while the dropdown menu 54d is set to “OR,” the data resource could have either P1 or P2.

Optionally, one of the resource properties is the property of containing a particular class of data. In some disclosed embodiments, as shown in FIG. 2, checkboxes 58 in the relevant dropdown menu 54c allow the user to specify the class of data. Examples of data classes include personally identifiable information (PII), protected health information (PHI), and financial information (FI). Another, more general example is sensitive data, this class being defined, for example, as the union of two or more sub-classes such as personally identifiable information, protected health information, or financial information, such that a data resource is considered to contain sensitive data if the data resource contains data belonging to any one of the sub-classes. In other words, in some disclosed embodiments, by virtue of specifying the resource properties, the backup policy conditions apply the backup parameters on the sensitivity of data stored in each of the cloud resources.

Alternatively or additionally, one of the resource properties is the property of running in a particular type of runtime environment, or in any one of multiple types of runtime environments. Examples of runtime environments include a production environment (e.g., an internal production environment), a development environment, and a testing environment.

Alternatively or additionally, one of the cloud resource properties is the property of running a particular application or any one of multiple applications, e.g., any application of a particular type. Examples of types of applications are database applications, message queues, and web applications.

Alternatively or additionally, the cloud resource properties include the property of being of a particular type (e.g., the property of being a database), a location-related property (e.g., the property of being located in a particular geographic area), and/or a property relating to the manner in which the data resource is hosted by the cloud infrastructure (e.g., the property of being hosted in a particular account ID, virtual private cloud, or subnet).

In some disclosed embodiments, second sub-section 52 includes another button 62 via which the user can manually include resources in the policy or exclude resources from the policy, e.g., based on the user having tagged the resources.

In some disclosed embodiments, the backup parameters include a backup frequency (e.g., once a day), a required number of backup copies, and/or one or more required locations of destination servers 36 (FIG. 1), each location including, for example, a geographic region, a cloud infrastructure, a subnet, and/or an account. In some disclosed embodiments, another button 64 allows the user to add backup parameters.

In response to receiving the backup policy, the backup system 140 (FIG. 1) executes the backup policy, e.g., at the frequency specified by the user. During each execution of the backup policy, the backup system 140, based on the identified content of the cloud resources, identifies those of the cloud resources that have all the properties of any one of the sets of properties included in the policy, excluding any cloud resources that were manually excluded by the user. For example, the backup system 140 (FIG. 1) may identify at least some of the cloud resources that store a particular class of data, at least some of the cloud resources that run in a particular type of runtime environment, and/or at least some of the cloud resources that run a particular application or type of application. The processors further identify any cloud resources that were manually included by the user. The processors then back up the identified cloud resources in accordance with the backup parameters.

In some disclosed embodiments, alternatively or additionally to creating one or more backup policies, user 28 (FIG. 1) creates one or more backup posture controls. Each posture control specifies one or more backup requirements and at least one set of one or more resource properties. Backup system 140 is configured to receive the backup posture control from the user. Based on the identified content of the cloud resources, backup system 140 identifies at least some of the cloud resources that have the specified resource properties. The backup system 140 then ascertains whether each of the identified cloud resources is backed up in accordance with the backup requirements of the respective control(s). In response to any one of the cloud resources not being backed up in accordance with the backup requirements, the backup system 140 output a warning.

In some disclosed embodiments, the cloud resources are automatically backed up in accordance with one or more backup policies (e.g., content-based or conventional backup policies), such that the warning explicitly or implicitly indicates a need to modify the backup policies. For example, in the hypothetical scenario outlined above, the warning may indicate a need to exclude cloud resources containing personally identifiable information from a backup policy. Alternatively or additionally, the cloud resources are manually backed up, such that the warning explicitly or implicitly indicates a need to change the manner in which the cloud resources are backed up and/or a need to automate the backup process.

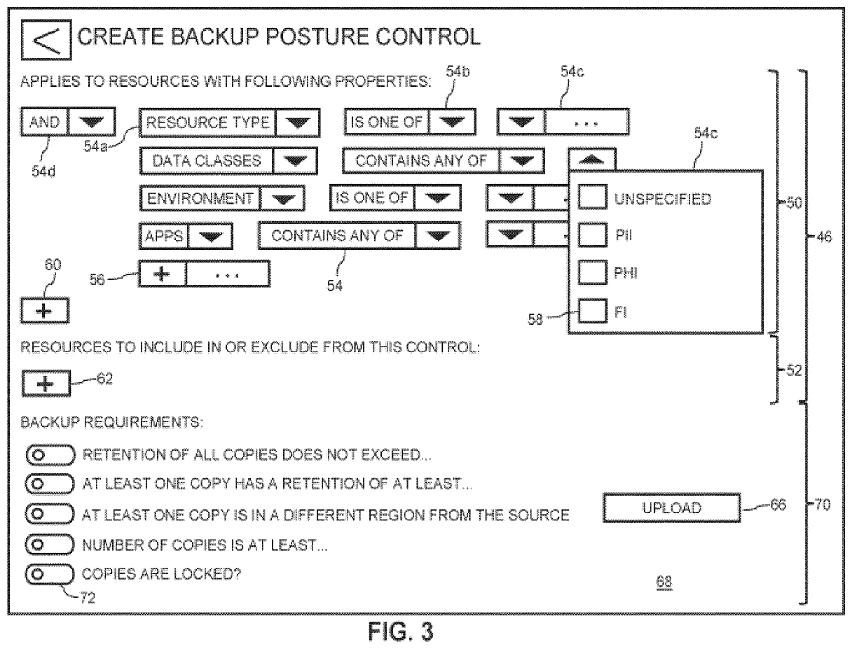

By way of illustration, reference is now made to FIG. 3, which is a schematic illustration of an example user interface 68 for creating a backup posture control, in accordance with some disclosed embodiments. In some disclosed embodiments, user interface 68, or any suitable variation thereof, is displayed on device 30 (FIG. 1). The user uses the user interface to create a backup posture control, and the backup posture control is then uploaded to backup system 140 (FIG. 1) from device 30, e.g., in response to the user hitting upload button 66.

In some disclosed embodiments, user interface 68 includes first section 46, in which the user can specify information to be used for determining the cloud resources to be included in the posture control, as explained above for user interface 44 (FIG. 2). It is noted that, notwithstanding the similarities between FIG. 2 and FIG. 3 with respect to first section 46, the two user interfaces may differ from one another with respect to the layout of first section 46 and/or the manner in which the resource properties are specified.

In some disclosed embodiments, user interface 68 further includes a second section 70, in which the user can define the backup requirements to be applied to the cloud resources included in the posture control. In some disclosed embodiments, each requirement is specified by toggling a respective toggle switch 72 and then, if required, entering the parameters of the requirement.

The requirements can include, for example, a constraint on the retention of a backup, such as a stipulation that no backup copies be retained for longer than a particular maximum retention period and/or that at least one copy should be retained for at least a particular minimum retention period. Alternatively or additionally, the requirements can include a constraint on the destination of a backup, such as a stipulation that at least one backup copy be in a particular geographic region, that no copies be in a particular geographic region, or that at least one backup copy be sufficiently isolated from the data source by virtue of being hosted in a different geographic region, hosted in association with a different account ID, or hosted by a different cloud infrastructure. Alternatively or additionally, the requirements can include a constraint on a number of backup copies, such as a stipulation that the number of copies be at least a particular threshold. Alternatively or additionally, the requirements can include a constraint on the lockedness of a backup, i.e., the extent to which the backup copies are protected from modification or deletion.

In response to receiving the backup posture control, the backup system 140 (FIG. 1) is configured to execute the backup posture control, e.g., at a predetermined frequency (e.g., once per hour) or a frequency specified by the user. During each execution of the backup posture control, the backup system 140, based on the identified content, identifies those of the cloud resources that have all the resource properties of any one of the sets of properties included in the control, excluding any cloud resources that were manually excluded by the user. For example, the backup system 140 may identify at least some of the cloud resources that store a particular class of data, at least some of the cloud resources that run in a particular type of runtime environment, and/or at least some of the cloud resources that run a particular application or type of application. The backup system 140 further identifies any cloud resources that were manually included by the user. The backup system 140 then ascertains whether each of the identified cloud resources is backed up in accordance with the backup requirements. In response to any one of the cloud resources not being backed up in accordance with the backup requirements, the backup system 140 outputs a warning. The warning may specify, for example, the identity of the data resource and those of the backup requirements that are not satisfied for the data resource.

Typically, to ascertain whether each of the identified cloud resources is backed up in accordance with the backup requirements, the backup system 140 first identifies any backups of the cloud resources. For example, in some disclosed embodiments, the backup system 140 performs at least some of the backing up (e.g., by executing content-based backup policies), such that the backup system 140 can readily identify the backups. Alternatively or additionally, for disclosed embodiments in which backups are performed manually and/or via an external backup service, the processors scan the user's accounts and/or connect to an application programming interface of an external backup service. Subsequently, the backup system 140 checks whether the backups conform to the backup requirements.

In various disclosed embodiments, a method may be implemented for managing backup posture controls of backup of cloud resources within a cloud infrastructure. The method may include probing one or more accounts associated with the cloud infrastructure in order to identify the content of multiple cloud resources hosted in connection with the accounts. A backup posture control may then be received from a user of the accounts, the control specifying one or more backup requirements along with at least one set of resource properties. Based on the identified content, a subset of the cloud resources that exhibit the specified resource properties is identified. The method may further determine whether each of the identified cloud resources is backed up in accordance with the defined backup requirements. If it is determined that any of the identified cloud resources are not backed up in accordance with the backup requirements, the method generates new backup policies and/or updates existing backup to meet the requirements set by the controls.

It is important to distinguish that backup posture controls differ from backup policies. A backup policy is a defined set of rules, parameters, and procedures that govern how cloud resources are copied, stored, and retained for the purpose of data protection. Such a policy may specify conditions including, but not limited to, backup schedules (e.g., frequency and timing), storage locations (e.g., specific regions, accounts, or providers), redundancy requirements (e.g., number of copies), retention periods (e.g., minimum and maximum durations), and security constraints (e.g., encryption or geographic restrictions). The purpose of a backup policy is to ensure that data can be reliably recovered in the event of loss, corruption, or disaster, while also meeting organizational, operational, or regulatory requirements.

A backup posture control may be defined by a user to govern how cloud resources are protected within a cloud infrastructure. Specifically, a backup posture control constrains backup requirements through a set of rules that extend beyond individual backup policies, thereby ensuring compliance with organizational or regulatory rules. Such backup requirements may include, for example: (i) a minimum number of backup copies; (ii) a minimum number of geographic regions in which the copies must be stored; (iii) distribution of backups across multiple cloud providers; (iv) maximum retention periods; (v) minimum retention periods; (vi) storage of backup copies in separate accounts; and (vii) restrictions that limit backups to designated geographic regions. Additional requirements may also be established.

In many cases, compliance with all applicable backup posture controls requires assigning multiple backup policies to the same resource. For example, a user may set a backup posture control to ensure that all machines containing personally identifiable information (PII) are backed up only within Europe, while also requiring that all machines with virtual machine (VM) names containing “DB” are backed up to the United States. Based on such control, separate backup policies may be created, such as one requiring backup of machines with PII to a Frankfurt data center, and another requiring backup of machines with “DB” in the name to a U.S. location. While each backup policy may operate as intended independently, a conflict may arise if a single machine contains both PII and has a “DB” designation, as existing policies may not recognize or resolve such conflicting requirements.

In a disclosed embodiment, the backup system 140 is configured to generate a set of new backup polices based on backup posture controls defined by the user. This includes setting new backup locations (vaults), setting new backup accounts, and determining the backup schedules and retention policy so that the backup requirements set in the respective control are fully met. The creation of the new backup policies does not require user involvement.

In another embodiment, existing backup polices are optimized based on the defined backup posture controls. This may include, for example, detecting and resolving conflicting policies or policies violating the controls. Optimizing or modifying conflicting policies may also require setting new backup locations (cloud vaults), setting new backup accounts, and determining the backup schedules and retention policy so that the backup requirements set in the respective controls are fully met. The creation of the new backup policies does not require user involvement.

It should be noted that while users are capable of defining backup policies and backup posture controls, the disclosed embodiments provide optimization capabilities that cannot be achieved by users alone. Specifically, a user may not have visibility into the underlying infrastructure of the cloud computing environment that is subject to backup, and therefore may be unable to configure policies that achieve cost reductions.

Additionally, multiple users within the same organization may independently define different backup policies, which can lead to conflicts. Further, users may lack awareness of compliance requirements applicable to target backup locations. For instance, a user located in the United States may not be familiar with data protection regulations applicable in Europe, and thus may configure backup policies that inadvertently violate such requirements.

By way of example, the disclosed embodiments may modify or optimize backup policies in situations where such policies conflict with one another. For instance, a user may request that workloads containing personally identifiable information (PII) be backed up exclusively within Europe, while also requesting that databases be backed up to another geographic region.

The disclosed embodiments include a method and backup system 140 that can detect and resolve such policy conflicts. In a disclosed embodiment, when conflicts arise in the definitions of backup policies, an order of precedence may be applied among the controls such that certain rules override others. To this end, the disclosed embodiments may assign priority to each control, thereby establishing a strict hierarchy among the controls. For example, a control corresponding to regulatory requirements, such as the General Data Protection Regulation (GDPR) restriction against backing up PII outside of Europe, may be assigned the highest priority. In contrast, a control requiring that data copies be distributed across two continents may be assigned a lower priority. As a result, workloads containing GDPR-governed PII will not be backed up outside of Europe, even if another control would otherwise direct the data to multiple continents.

According to the disclosed embodiments, a backup posture control may be optimized to include one or more optimization rules. An optimization rule may include an enablement rule and an avoidance rule. An enablement rule is when more copies of backup data are needed, or a retention period of the backup has to be extended. An avoidance rule is when no backup copy should be kept in a certain location or when the retention period of the backup has to be shortened.

In certain embodiments, workload-specific rules are defined to support newly created or modified policies. As part of this configuration, the backup system 140 may instantiate one or more vaults across different clouds and regions, and may also create new backup accounts within the cloud infrastructure to satisfy defined backup posture controls. In some implementations, the system 140 may determine the number of vaults to be instantiated and the number of new backup accounts to be created based on an analysis of the backup controls. The optimization process may also involve generating new backup policies for cloud resources that do not comply with existing backup policies.

Furthermore, identifying cloud resources that satisfy specified resource properties may include determining cloud resources that store a particular class of data, such as personally identifiable information (PII), databases, or other categorized resource types.

In certain embodiments, creation and optimization of backup policies may reduce storage and operational costs associated with backups and minimize compute resources consumed during backup processes.

For example, the decision regarding where to instantiate new vaults or new accounts may be guided by a cost function. The cost function may relate to one or more cost factors associated with the use of cloud infrastructure resources, including, for example, compute, storage, network egress, or inter-region transfer charges. The backup system 140 may apply such a cost function when optimizing the placement of vaults and accounts so that backup policies and posture controls are satisfied while minimizing overall operational expenses. In this manner, the backup system 140 provides further optimization that balances compliance and redundancy requirements against cost efficiency.

The following are some examples of cost optimization. Storage tier selection: backups that are infrequently accessed may be directed to lower-cost archival or cold storage classes, whereas frequently accessed backups may remain in standard storage. Region-aware placement: when posture controls permit flexibility in region selection, the backup system 140 may choose regions with lower storage or compute costs while still maintaining compliance with geographic restrictions. Cross-provider optimization: backups may be distributed across multiple cloud providers, and the system may favor providers offering lower costs for equivalent storage or retention requirements. Account-level distribution by instantiating new backup accounts strategically, the backup system 140 can reduce per-account overhead charges and optimize resource usage across organizational accounts. Data transfer minimization, the cost function may account for network egress fees, and the system may favor vault placement in regions that reduce or eliminate cross-region transfer charges.

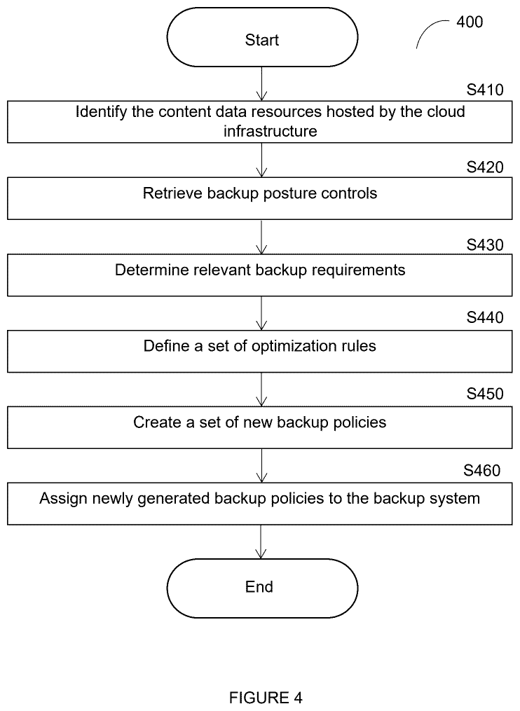

FIG. 4 shows an example flowchart 400 describing the method for optimizing backup posture controls in accordance with the disclosed embodiments. The method may be performed by the backup system 140.

At S410, one or more accounts on a cloud infrastructure are probed to identify the content of multiple cloud resources hosted by the cloud infrastructure in association with the accounts. In an embodiment, S410 may include taking respective snapshots of cloud resources, mounting the snapshots on a different virtual machine, and then scanning the snapshots to identify the content stored therein. In another embodiment, S410 may further include scanning the cloud resources directly, using one or more agents installed on workloads hosting the data.

Alternatively, or additionally, S410 may include scanning data files of the backup copies (e.g., stored in servers 26, FIG. 1) and/or backup metadata. Data files may include content exported from cloud resources. For example, content may be exported from the database, the database schema, a combination thereof, or the like. In an embodiment, data files may include a plurality of files, each stored as a column-oriented data file. A column-oriented data file may be, but is not limited to, an Apache® Parquet file. For example, in an embodiment, data files are stored in Parquet format.

The backup metadata may include information that allows the generation of a restored machine. Such metadata may comprise a filesystem, directory, registry, software product keys, or a combination thereof. For example, a machine backup may include an identifier of an operating system (e.g., Windows®, Linux®), an identifier of a database application (e.g., Apache® Derby), a filesystem, a registry file, a configuration file, or the like. Backup metadata also includes information used to verify the integrity of the DB backup. This includes configuration parameters, the database schema, and integrity metadata, as discussed below. Therefore, by scanning or querying the data files and/or metadata of the backup, the types of content included in such backup can be determined.

In yet another embodiment, the identification of cloud resources includes the identification or classification of types or properties of cloud resources. For example, cloud resources can be classified as sensitive, e.g., by virtue of including PII, financial information, and/or protected health information. In yet another embodiment, S410 may include identifying classes of data stored in the cloud resources, applications installed on the data resources, and/or metadata variables saved on the data resources.

At S420, backup posture controls are retrieved. As noted above, such control specifies one or more backup requirements through a set of rules. A user of the backup system may set the controls. Embodiments for setting the backup posture controls are discussed above. For example, a user interface for creating a backup posture control is shown in FIG. 3.

At S430, for each backup posture control, the relevant backup requirements are determined. Specifically, the backup requirements set for the relevant control with respect to the resource are detected. As noted above, such requirements may include, for example: (i) a minimum number of backup copies; (ii) a minimum number of geographic regions in which the copies must be stored; (iii) distribution of backups across multiple cloud providers; (iv) maximum retention periods; (v) minimum retention periods; (vi) storage of backup copies in separate accounts; and (vii) restrictions that limit backups to designated geographic regions.

At S440, based on the backup requirements for the backup posture control, a set of optimization rules is defined. As noted above, an optimization rule may include an enablement rule and an avoidance rule. An enablement rule is when more copies of backup data are needed, or a retention period of the backup has to be extended. An avoidance rule occurs when no backup copy should be kept in a certain location or when the retention period of the backup must be shortened.

At S450, new backup policies are created or otherwise defined. Specifically, in an embodiment, the new policies are set to meet the backup requirements for the backup posture controls, the optimization rules, and the types of identified cloud resources.

In an embodiment, S450 processes may be performed in multiple phases. In a first phase, the control logic may enforce the optimization rules. For example, if a control specifies that certain resources are to be excluded from backup, or that a retention period is to be shortened, and no higher-priority control requires otherwise, the method may automatically exclude the affected cloud resources from the backup policy that would otherwise violate such rules. In a subsequent phase, workload-specific rules may be applied. Certain workloads may require a specific number of backup copies, and then such a number of new backup policies targeted specifically for that workload would be created.

In an embodiment, S450 may also include creating one or more backup vaults across different clouds and geographic regions to ensure sufficient backup targets in accordance with redundancy, geographic diversity, and regulatory requirements of the controls; and instantiating additional backup accounts within the cloud infrastructure to satisfy multi-account requirements imposed by the controls, thereby distributing workloads across independent accounts.

S450 may further include configuring the cloud resources with the new policies, thereby ensuring that such policies would not violate the copy count, retention limits, or geographic restrictions defined in the respective backup posture control. In an embodiment, S450 may further include generating new policies for particular workloads, thereby ensuring that such workloads meet the defined backup posture controls.

In an embodiment, S450 may include considering one or more cost functions when generating the backup policies. The cost function may relate to one or more cost factors associated with the use of cloud infrastructure resources, including, for example, compute, storage, network egress, or inter-region transfer charges. Examples for such functions are provided above.

At S460, the newly generated backup polices are assigned to the backup system. This ensures that subsequent backup operations, by the backup systems, are automatically executed under these new policies. It should be noted that a policy may be generic or per resource. This allows for automatically defining policies, which are discussed herein.

The following is an example illustrating the disclosed process for defining a new backup policy where none previously existed for a particular workload. For instance, an organization onboards a new set of virtual machines (VMs) hosting a machine learning application. No backup policy has yet been applied or defined to these VMs. A user-defined backup posture control that all workloads classified as “critical” must (i) maintain at least three backup copies, (ii) distribute those copies across at least two geographic regions, and (iii) store at least one copy on a separate cloud provider.

When the new VMs are detected, the process initiates the creation of a new backup policy. The process may proceed as follows: VMs are identified or classified as “critical” based on metadata tags supplied by the user or by automated inspection; because no suitable vaults currently exist that satisfy the three-copy/two-region/multi-provider rule, the process instantiates a new vault in the primary cloud region (e.g., AWS Frankfurt) and another vault in a secondary region of the same provider (e.g., AWS Dublin). Then, a provider placement takes place to satisfy the requirement of storing at least one copy on a different provider. That is, the process creates a vault on another cloud (e.g., Azure Netherlands).

The next step is a policy definition where a new backup policy is then generated, specifying that:
I. One copy is written to AWS Frankfurt;
II. One copy is written to AWS Dublin; and
III. One copy is written to Azure Netherlands. Retention periods are defined in accordance with the posture controls (e.g., 2-year minimum retention).

The last step is to assign the new backup policy to the machine learning workload. Subsequent backup operations are automatically executed under this new policy. As a result, the newly onboarded workload is fully compliant with the backup posture controls without requiring modification of any existing policies.

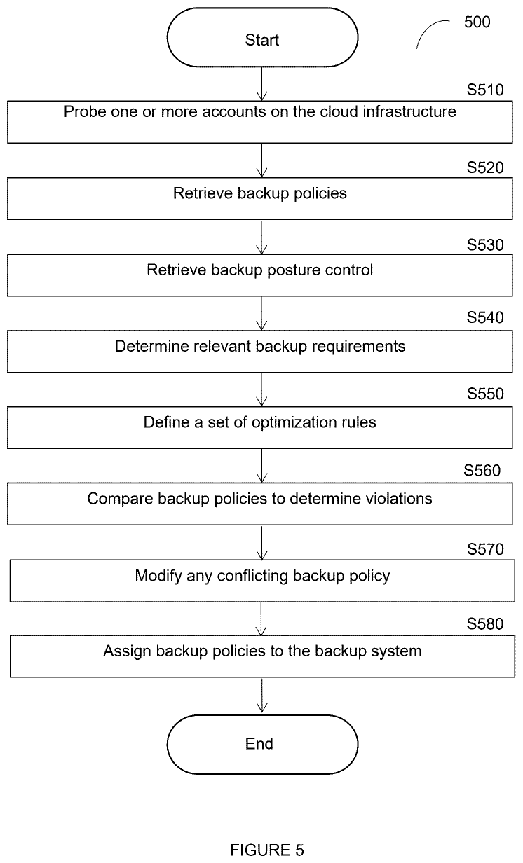

FIG. 5 shows an example flowchart 500 describing the method for optimizing backup posture controls in accordance with the disclosed embodiments. The method may be performed by the backup system 140.

At S510, one or more accounts on a cloud infrastructure are probed to identify the content of multiple cloud resources hosted by the cloud infrastructure in association with the accounts. In an embodiment, S510 may include taking respective snapshots of cloud resources, mounting the snapshots on a different virtual machine, and then scanning the snapshots to identify the content stored therein. In another method embodiment, S510 may further include scanning the cloud resources directly, using one or more agents installed on workloads hosting the data.

Alternatively, or additionally, S510 may include scanning data files of the backup copies (e.g., stored in servers 26, FIG. 1) and/or backup metadata. Data files may include content exported from cloud resources. For example, content may be exported from the database, the database schema, a combination thereof, or the like. In an embodiment, data files may include a plurality of files, each stored as a column-oriented data file. A column-oriented data file may be, but is not limited to, an Apache® Parquet file. For example, in an embodiment, data files are stored in Parquet format.

The backup metadata may include information that allows the generation of a restored machine. Such metadata may comprise a filesystem, directory, registry, software product keys, or a combination thereof. For example, a machine backup may include an identifier of an operating system (e.g., Windows®, Linux®), an identifier of a database application (e.g., Apache® Derby), a filesystem, a registry file, a configuration file, or the like. Backup metadata also includes information used to verify the integrity of the DB backup. This includes configuration parameters, the database schema, and integrity metadata, as discussed below. Therefore, by scanning or querying the data files and/or metadata of the backup, the types of content included in such backup can be determined.

In an embodiment, the identification of cloud resources includes the identification or classification of cloud resources. For example, if the data resource includes sensitive data, PII data, and the like. In yet another embodiment, S510 may include identifying classes of data stored in the cloud resources, applications installed on the data resources, and/or metadata variables saved on the data resources.

At S520, backup policies are retrieved. A backup policy is a defined set of rules, parameters, and procedures that govern how cloud resources are copied, stored, and retained for the purpose of data protection. A user of the backup system may set the backup policies. Embodiments for setting the backup policies are discussed above. For example, a user interface for creating a backup policy is shown in FIG. 2.

At S530, backup posture controls are retrieved. As noted above, such control specifies one or more backup requirements through a set of rules. A user of the backup system may set the controls. Embodiments for setting backup posture controls are discussed above. For example, a user interface for creating a backup posture control is shown in FIG. 3. As discussed above, backup posture controls differ from backup policies.

At S540, for each backup posture control, the relevant backup requirements are determined. Specifically, the backup requirements set for the relevant control with respect to the resource are detected. As noted above, such requirements may include, for example: (i) a minimum number of backup copies; (ii) a minimum number of geographic regions in which the copies must be stored; (iii) distribution of backups across multiple cloud providers; (iv) maximum retention periods; (v) minimum retention periods; (vi) storage of backup copies in separate accounts; and (vii) restrictions that limit backups to designated geographic regions.

In an embodiment, S540 further includes defining a set of optimization rules based on the backup requirements for the backup posture control. As noted above, an optimization rule may include an enablement rule and an avoidance rule. At S550, based on the backup requirements for the backup posture control, a set of optimization rules is defined. As noted above, an optimization rule may include an enablement rule and an avoidance rule.

At S560, the backup requirements are compared to the backup policies to determine whether controls are being violated. The comparison is performed with respect to the identified resources. For example, if an identified resource is a database that contains PII and the backup requirements (of a control) do not allow copying such data outside Europe, and the policy allows copying such data to any region, then this would be determined as a violation of the control. Any backup policy that violates at least one backup posture control is referred to as a conflicting backup policy.

At S570, any conflicting backup policy is modified to resolve the conflict. The modification includes deleting an existing policy, adding one or more policies, and/or optimizing an existing policy.

In some embodiments, S570 includes modifying backup policies to ensure compliance with the backup posture controls, optimization rules, and the types of identified resources. The modification process may be performed in multiple phases.

In a first phase, the control logic may enforce the optimization rules. For example, if a control specifies that certain resources are to be excluded from an existing backup policy, or that a retention period is to be shortened, and no higher-priority control requires otherwise, the process may automatically exclude the affected resources from the backup policy that would otherwise violate the requirements of a control.

In a subsequent phase, workload-specific rules may be applied. Such rules define the backup requirements for a workload. For example, certain workloads may require additional redundancy that is not satisfied by existing policies. For example, if a workload requires four backup copies and existing policies provide only three copies, the process may generate a new policy targeted specifically for that workload. To implement such a modified policy, the process may instantiate a new backup vault, if one does not already exist, and direct the workload's backup to that vault.

In an embodiment, the process of (S570) modifying conflicting security policy may include: creating one or more vaults across different clouds and geographic regions to provide sufficient backup targets in accordance with posture controls and optimization rules. Alternatively or additionally, the process may include instantiating additional backup accounts as needed to satisfy multi-account requirements imposed by the controls. Alternatively or additionally, the process may include removing resources from existing policies when such policies would cause a violation of copy, retention, or location requirements. Alternatively or additionally, the process may include generating new backup policies for individual workloads that do not comply with current policies, thereby ensuring that such workloads meet the applicable backup posture controls.

In a disclosed embodiment, S570 may include considering one or more cost functions to modify the conflict backup policies. The cost function may relate to one or more cost factors associated with the use of cloud infrastructure resources, including, for example, compute, storage, network egress, or inter-region transfer charges. Examples for such functions are provided above.

At S580, the modified (including any new) backup policies are assigned to the backup system (e.g., backup system 140, FIG. 1) or any processer that can run the backup process. This ensures that subsequent backup operations, by the backup system, are automatically executed under these new policies.

Following is an example demonstrating the operation of the process for modifying conflicting backup policies as discussed above. In this example, two backup posture controls are defined: (i) all resources containing personally identifiable information (PII) must remain within Europe in accordance with GDPR; and (ii) all databases must be backed up in at least two different geographic regions. During optimization, the process probes the cloud accounts and identifies a database that contains PII. A conflict arises because the general database policy would direct the backup to one region in Europe and one region in the United States.

According to the disclosed embodiments, the process resolves this conflict as follows: First, an enforcement rule is applied on the GDPR control as a higher priority, excluding the database from the general database policy that specifies U.S. replication. Next, the process defines a workload-specific rule requiring two copies of the PII database within Europe. To satisfy this, a new vault is created in a second European region (e.g., Frankfurt and Dublin). If no suitable vault exists, a new vault is instantiated automatically. Additionally, if a multi-account requirement applies, a new backup account in one of the European regions to host a copy is created. As a result, the database is backed up in compliance with both redundancy and GDPR requirements while avoiding policy conflicts.

FIG. 6 is a schematic diagram of an example physical machine implementation of the backup system 140, in accordance with an embodiment of the present disclosure.

The hardware blocks in FIG. 6 are suitable for executing the functional logic attributed to optimizing and creating backup policies as discussed herein. The backup system 140 includes, according to an embodiment, a processing circuitry 610 coupled to a memory 620, a storage 630, and a network interface 640. In a disclosed embodiment, the components of the backup system 140 are communicatively connected via a bus 650.

In certain embodiments, the processing circuitry 610 is realized as one or more hardware logic components and circuits. For example, illustrative types of hardware logic components include field-programmable gate arrays (FPGAs), application-specific integrated circuits (ASICs), application-specific standard products (ASSPs), system-on-a-chip systems (SoCs), graphics processing units (GPUs), tensor processing units (TPUs), artificial-intelligence (AI) accelerators, general-purpose microprocessors, microcontrollers, digital-signal processors (DSPs), and the like, or any other hardware logic components that are configured to perform calculations or other manipulations of information. In some implementations the processing circuitry allocates separate execution contexts, such as threads, processes, or micro-services, to snapshot/object orchestration, page tokenization, token-map ingestion and update, index-artifact publication/discovery, read-path servicing for segment requests, restoration and integrity verification, append-based content/object writing, and checkpointing, so that none of these tasks block the others.

In a disclosed embodiment, the memory 620 is a volatile memory (e.g., random-access memory, etc.), a non-volatile memory (e.g., read-only memory, flash memory, etc.), a combination thereof, and the like. In some disclosed embodiments, the memory 620 is an on-chip memory, an off-chip memory, a combination thereof, and the like. In certain disclosed embodiments, the memory 620 is a scratch-pad memory for the processing circuitry 610.

In one configuration, software for implementing one or more embodiments disclosed herein is stored in the storage 630, in the memory 620, in a combination thereof, and/or on a separate repository accessible via the network interface 640. “Software” shall be construed broadly to mean any type of instructions, whether referred to as software, firmware, middleware, microcode, hardware-description language, or otherwise. When executed, the instructions cause the processing circuitry 610 to perform the processes disclosed herein. In some disclosed embodiments, the memory 620 or storage 630 may maintain a data structure (e.g., a bitmap or table) that tracks tokenized outputs, content/object fragments, index-artifact segments, and checkpoints that have been persisted, enabling the backup system 140 to recover from transient faults and resume processing from a consistent state.

In some disclosed embodiments, the storage 630 is a magnetic storage, an optical storage, a solid-state storage, a combination thereof, and the like, and is realized, according to an embodiment, as a flash memory, as a hard-disk drive, another memory technology, various combinations thereof, or any other medium which can be used to store the desired information.

The network interface 640 is configured to provide the backup system 140 with communication with, for example, the network 130, the computing environment 110, backup storage 160 (including index-artifact namespaces 185, content objects, and tokenized outputs), and the like, according to an embodiment. Interface 640 may expose any combination of protocols or Application programming interfaces (APIs) needed to reach snapshot services and object stores, such as REST for snapshot APIs and S3-compatible calls for object storage, and may support scanning of discovery locations for index artifacts and publication of newly generated artifacts.

It should be understood that the disclosed embodiments described herein are not limited to the specific architecture illustrated in FIG. 6, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine is implemented on a computer platform having hardware such as one or more processing units (“PUs”), a memory, and input/output interfaces. The computer platform may also include an operating system and microinstruction code. The various processes and functions described herein may be either part of the microinstruction code or part of the application program, or any combination thereof, which may be executed by a PU, whether or not such a computer or processor is explicitly shown. In addition, various other peripheral units may be connected to the computer platform such as an additional data storage unit and a printing unit. Furthermore, a non-transitory computer readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to the first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for generating backup policies based on backup posture controls, comprising:
probing one or more accounts on a cloud infrastructure so as to identify content of cloud resources hosted by the cloud infrastructure in association with the accounts;
retrieving a set of backup posture controls, wherein the set of backup controls defines backup requirements on the identified cloud resources;
analyzing the backup requirements to create optimization rules and workload-specific rules;
creating at least one backup policy based on the optimization rules and workload-specific rules; and
assigning the at least one backup policy to a backup system to allow backup operations of the cloud resources based on the at least one backup policy.

2. The method of claim 1, wherein the at least one backup policy differs from a backup posture control in the set of backup posture controls, wherein the set of backup posture controls is configured by a user of the backup system.

3. The method of claim 2, wherein the optimization rule includes: any one of: an enablement rule and an avoidance rule, wherein the enablement rule is when more copies of backup data are needed, or a retention period of the backup has to be extended, and wherein the avoidance rule is when no backup copy should be kept in a certain location or when the retention period of the backup has to be shortened.

4. The method of claim 3, wherein creating the at least one backup policy further comprises:
applying the optimization rules on the backup posture controls, thereby optimizing the backup policy.

5. The method of claim 1, wherein workload-specific rules define backup requirements for a workload hosting an identified data resource.

6. The method of claim 5, wherein creating the at least one backup policy further comprises:
determining a minimal number of required vaults and a minimal number of new backup accounts to meet the backup requirements.

7. The method of claim 5, further comprising:
instantiating required vaults in locations satisfying the backup requirements; and
instantiating the required backup accounts in the cloud infrastructure.

8. The method of claim 7, wherein the instantiation of the required vaults and backup accounts is performed while satisfying a cost function selected to reduce the overall cost of the backup.

9. The method of claim 2, further comprising:
retrieving backup policies defined for the cloud resources;
comparing the backup requirements to the retrieve backup policies to detect conflicting backup policies, wherein a conflicting backup policy violates at least one backup posture control of the set of backup posture controls; and
modifying the detected conflicting backup policies, thereby optimizing the existing backup policies.

10. The method of claim 1, further comprising:
querying backup files to identify the content of multiple cloud resources.

11. A non-transitory computer-readable medium storing a set of instructions for generating backup policies based on backup posture controls, the set of instructions comprising:
one or more instructions that, when executed by one or more processors of a device, cause the device to:
probe one or more accounts on a cloud infrastructure so as to identify content of cloud resources hosted by the cloud infrastructure in association with the accounts;
retrieve a set of backup posture controls, wherein the set of backup controls defines backup requirements on the identified cloud resources;
analyze the backup requirements to create optimization rules and workload-specific rules;
create at least one backup policy based on the optimization rules and workload-specific rules; and
assign the at least one backup policy to a backup system to allow backup operations of the cloud resources based on the at least one backup policy.

12. A system for generating backup policies based on backup posture controls comprising:
a processing circuitry;
a memory, the memory containing instructions that, when executed by the processing circuitry, configure the system to:
probe one or more accounts on a cloud infrastructure so as to identify content of cloud resources hosted by the cloud infrastructure in association with the accounts;
retrieve a set of backup posture controls, wherein the set of backup controls defines backup requirements on the identified cloud resources;
analyze the backup requirements to create optimization rules and workload-specific rules;
create at least one backup policy based on the optimization rules and workload-specific rules; and
assign the at least one backup policy to a backup system to allow backup operations of the cloud resources based on the at least one backup policy.

13. The system of claim 12, wherein the at least one backup policy differs from a backup posture control in the set of backup posture controls, the set of backup posture controls is configured by a user of the backup system.

14. The system of claim 13, wherein the optimization rule includes:
any one of:
an enablement rule and an avoidance rule, wherein the enablement rule is when more copies of backup data are needed, or a retention period of the backup has to be extended, and wherein the avoidance rule is when no backup copy should be kept in a certain location or when the retention period of the backup has to be shortened.

15. The system of claim 14, wherein the memory contains further instructions that, when executed by the processing circuitry for creating the at least one backup policy, further configure the system to:
apply the optimization rules on the backup posture controls, thereby optimizing the backup policy.

16. The system of claim 13, wherein the memory contains further instructions which when executed by the processing circuitry further configure the system to:
retrieve backup policies defined for the cloud resources;
compare the backup requirements to the retrieve backup policies to detect conflicting backup policies, wherein a conflicting backup policy violates at least one backup posture control of the set of backup posture controls; and
modify the detected conflicting backup policies, thereby optimizing the existing backup policies.

17. The system of claim 12, wherein workload-specific rules define backup requirements for a workload hosting an identified data resource.

18. The system of claim 17, wherein the memory contains further instructions that, when executed by the processing circuitry for creating the at least one backup policy, further configure the system to:
determine a minimal number of required vaults and a minimal number of new backup accounts to meet the backup requirements.

19. The system of claim 17, wherein the memory contains further instructions which when executed by the processing circuitry further configure the system to:
instantiate required vaults in locations satisfying the backup requirements; and
instantiate the required backup accounts in the cloud infrastructure.

20. The system of claim 19, wherein the instantiation of the required vaults and backup accounts is performed while satisfying a cost function selected to reduce the overall cost of the backup.

21. The system of claim 12, wherein the memory contains further instructions which when executed by the processing circuitry further configure the system to:
query backup files to identify the content of multiple cloud resources.
